(19) United States
(12) Patent Application Publication
(10) Pub. No.: US 2025/0303941 A1
(43) Pub. Date: Oct. 2, 2025

(54) SEAT TRIM ASSEMBLY

(71) Applicants: FAURECIA Sièges d'Automobile, NANTERRE (FR); Indorama Ventures Mobility Obernburg GmbH, Obernburg (DE)

(72) Inventors: Mathieu CLUET, ETAMPES (FR); Benoît GAZANIOL, ARPAJON (FR); Mathieu BOQUET, VERRIERES LE BUISSON (FR)

(21) Appl. No.: 19/089,403

(22) Filed: Mar. 25, 2025

(30) Foreign Application Priority Data
Mar. 29, 2024 (FR) 2403270

(51) Int. Cl. B60N 2/58; B33Y 10/00; B33Y 80/00

(52) U.S. Cl. CPC B60N 2/5891; B33Y 80/00; B60N 2/5841; B33Y 10/00

(57) ABSTRACT

The present disclosure relates to trim assembly comprising: a first layer of padding comprising a 3D entanglement of irregularly-arranged continuous polyester fibers forming loops welded together, a cover comprising: a second layer comprising non-woven polyester fibers, a decorative third layer comprising polyester fibers woven together, each of the first and second layers comprising at least 95% polyester, the third layer comprising at least 92% polyester.

### PRIORITY CLAIM

This application claims priority to French Patent Application No. FR2403270, filed Mar. 29, 2024, which is expressly incorporated by reference herein.

### BACKGROUND

The present disclosure relates to X, and particularly to Y. More particularly, the present disclosure relates to Z.

The present disclosure lies within the field of motor vehicle seats which comprise at least some trim assembly, for example, fixed to a seat structure. The trim assembly comprises a layer of padding which contributes to seat comfort, and a cover which in particular serves to provide a finishing touch by covering the padding. The cover generally comprises at least one layer of decorative fabric.

The present disclosure relates to seat trim assembly, in particular for a seat backrest, although it is also possible to apply it to the seating part of the seat. The present disclosure also relates to a seat comprising such trim assembly, as well as to a method for recycling such trim assembly.

### SUMMARY

According to the present disclosure, a trim assembly is proposed which comprises:
a first layer of padding comprising a 3D entanglement of irregularly-arranged continuous polyester fibers forming loops welded together,
a cover comprising:
a second layer comprising non-woven polyester fibers,
a third layer, decorative and comprising polyester fibers woven together or knitted together,
each of the first and second layers comprising at least 95% polyester, the third layer comprising at least 92% polyester.

Thus, for the reasons discussed below, the trim assembly according to the present disclosure is made entirely of recyclable material and has a reduced level of CO2 emission compared to comparative products.

According to a second aspect, a vehicle seat is proposed, comprising a backrest portion and a seating part portion which are connected to a vehicle seat structure, at least one among the backrest and seating part portions comprising trim assembly according to the first aspect.

According to some examples, the seat according to the second aspect comprises an interface fixed to the seat structure, the interface comprising a fastening area. In some examples, the trim assembly is placed on the interface on the side of the first layer of padding, such that the first layer is closest to the interface relative to the second and third layers, the first layer and the second layer comprising passages, the third layer comprising a fastening element capable of cooperating with the fastening area, the fastening element reaching the fastening area by passing through the passages of the first layer and second layer, to provide the attachment of the third layer. The first layer is thus sandwiched between the interface and the third layer, the first layer not being directly attached to the interface nor to the structure of the seat.

In some examples, the interface may be a plastic support type of interface, also called a “carrier”.

In other examples, the interface may be a metal suspension mat type of interface.

In some examples, the interface may be a backrest interface or a seating part interface.

According to a third aspect, a method for manufacturing a trim assembly is proposed wherein the manufacture of the first layer comprises:
/A1/Extruding a thermoplastic polymer in an extrusion die comprising extrusion nozzles distributed in a lengthwise direction and in a widthwise direction of the extrusion die, generating a curtain of continuous melted fibers which fall due to gravity,
/A2/Receiving the curtain of continuous melted fibers which fall due to gravity, on one or more support elements, with generation of a 3D entanglement of irregularly-arranged fibers with fusion of loops between the continuous fibers,
/A3/Optionally, solidifying the 3D entanglement of fibers by immersion in a cooling liquid.

According to a fourth aspect, an attachment method is proposed for fixing a trim assembly according to the present disclosure, to a vehicle seat according to the second aspect, the seat comprising an interface comprising a fastening area, the attachment method comprising:
/B1/Laying the first layer of padding on the interface,
/B2/Passing the fastening element through the passage in the first layer of padding, in order to fix it to the fastening areas of the interface.

According to one improvement, the attachment method for fixing the trim assembly to the vehicle seat may comprise, in /B3/, fixing the peripheral edges of the cover to the interface by cooperation between a rigid turned-in edge portion of the cover and a peripheral attachment area of the interface.

According to a fifth aspect, a method for recycling a vehicle seat according to the second aspect is proposed, comprising:
Separating the at least one trim assembly from the seat structure,
Crushing the entirety of the at least one trim assembly, with no prior operation of separating layers or layer elements, in order to obtain polyester in the form of granules,
Reusing at least part of the polyester granules to manufacture a product comprising polyester.

The features set forth in the following paragraphs may optionally be implemented, independently of each other or in combination with each other:

According to one improvement, the cover consists of:
a second layer comprising non-woven polyester fibers,
a third layer, decorative and comprising polyester fibers woven or knitted together,
the second layer comprising at least 95% polyester, and the third layer comprising at least 92% polyester.

According to one improvement, the cover comprises at least 92%

polyester, preferably at least 95% polyester, more preferably at least 96% polyester, even more preferably at least 98% polyester.

According to one improvement, each layer of the cover comprises at least 92% polyester.

According to one improvement, each layer of the cover is composed solely of polyester and sewing thread made of polyester or of another material, for example polyamide, and optionally one or more fastening means made of polyester or of another plastic material.

According to one improvement, the cover does not comprise viscose.

According to one improvement, the cover does not comprise polyurethane.

According to one improvement, the cover comprises, in addition to a second layer comprising non-woven polyester fibers and a third layer comprising polyester fibers woven or knitted together, one or more additional layers each comprising at least 92% polyester.

According to one example, an additional layer may be a layer that is relatively thin in thickness compared to the thicknesses of the second and third layers, for example between 0.5 and 1 mm. Such an additional layer may be positioned between the cover and the first layer of the trim assembly.

Generally speaking, it is understood that the term “layer” within the meaning of the present disclosure designates a layer of trim assembly which comprises fibers. These fibers may be non-woven, woven or knitted, or entangled with each other.

According to one improvement, the second layer and the third layer of the cover, and any additional layers, each comprise at least 92% polyester.

According to one improvement, the second layer comprises at least 98% non-woven polyester fibers.

In particular, the area density of the second layer may be between 180 g/m² for a thickness of 2.5 mm and 400 g/m² for a thickness of 4.3 mm.

In some examples, the second layer may be bonded to the third layer, preferably with a hot melt adhesive. The adhesive may comprise at least 95% polyester. The second layer may be bonded to the third layer by a hot melt adhering process.

In some examples, the cover may comprise one or more fastening elements configured to fix the cover to the first layer of padding or to an interface of a vehicle seat. The fastening elements may be, for example, sewn or bonded to an inner face of the cover, the inner face facing an interface of the seat and being opposite to an outer face that receives the seat occupant. The fastening element may comprise at least 95% polyester.

According to some examples, the fastening elements may be of the trim assembly tie-down type. The trim assembly may comprise one or more fastening elements.

In some examples, the first layer of padding may comprise one or more local areas which are made more dense and rigid by hot pressing the 3D entanglement, the fastening elements of the second layer being configured to cooperate with the local areas in order to fix the cover to the first layer of padding. For example, the fastening elements may comprise a set of hooks, and/or one or more points provided with hooks which catch on loops of the 3D entanglement of the layer of padding in the more dense and rigid local areas.

In other examples, the cover may be linked to the seat frame by the fastening elements. Optionally, the cover may then not be linked to the first layer of padding.

According to still other examples, the first layer of padding comprises a passage, the fastening element being configured to cooperate with a fastening area of the vehicle seat interface by passing through the passage in the first layer of padding.

According to some examples, the first layer of padding is placed on a vehicle seat interface, and the cover covers the first layer of padding by being fixed to the interface by one or more fastening elements. The fastening elements traverse the first layer of padding to reach the fastening areas of the interface.

According to some examples, the seat comprises an interface comprising a peripheral attachment area, and the cover comprises a rigid turned-in edge portion. The peripheral attachment area of the seat interface is configured to cooperate with the rigid portion of the cover to fix the cover on the interface.

The interface may be deformable, so as to contribute to seating comfort.

In some examples, the second layer may comprise a thickness that is at least two times, preferably at least five times, more preferably at least ten times greater than the thickness of the third layer. The second layer may be obtained by a lamination process, and may in particular be of a polyester “felt” type. The second layer may comprise a resin binder. The second layer may also be made of polyester. The second layer may comprise at least 95% polyester. The third layer may be obtained by a process of weaving polyester fiber together.

In one example, the thickness of the cover, which represents the addition of the thickness of the second layer plus the thickness of the third layer, may be less than the thickness of the first layer of padding. The cover may be two times, preferably five times, more preferably ten times less thick than the first layer of padding.

According to one example, the second layer comprises an area density of between 80 and 400 g/m², preferably between 100 and 250 g/m².

According to one example, the second layer comprises an air permeability that is greater than 1500 L/m²/s.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 shows a schematic representation of trim assembly according to one example of the present disclosure, intended for equipping a seat backrest.

FIG. 2 shows a perspective cross-section view of trim assembly according to one example, equipping a seat backrest.

FIG. 3 shows a perspective cross-section view of trim assembly according to one example, in which the three layers are particularly visible.

FIG. 4 shows a schematic plan view representation of a cross-section of trim assembly according to one example.

FIG. 5 shows a schematic representation of part of a method for obtaining trim assembly, according to one example of the present disclosure.

FIG. 6 shows a schematic cross-sectional representation of trim assembly fixed to a vehicle seat interface, according to one example of the present disclosure.

### DETAILED DESCRIPTION

The drawings and the description below contain elements which, for the most part, are certain in nature. Therefore, they may not only serve to provide a better understanding of the present disclosure, but where appropriate they may also contribute to its definition.

In the various figures, the same references designate identical or similar elements. For brevity, only those elements which are useful to understanding the described embodiment are shown in the figures and are described in detail below.

In the following description, when reference is made to absolute position qualifiers, such as the terms “front”, “rear”, “top”, “bottom”, “left”, “right”, etc., or to relative position qualifiers, such as the terms “above”, “below”, “upper”, “lower”, etc., or to orientation qualifiers, such as “horizontal”, “vertical”, etc., these refer unless otherwise specified to the orientation of the figures or of a vehicle seat element or of a vehicle seat in its normal position of use.

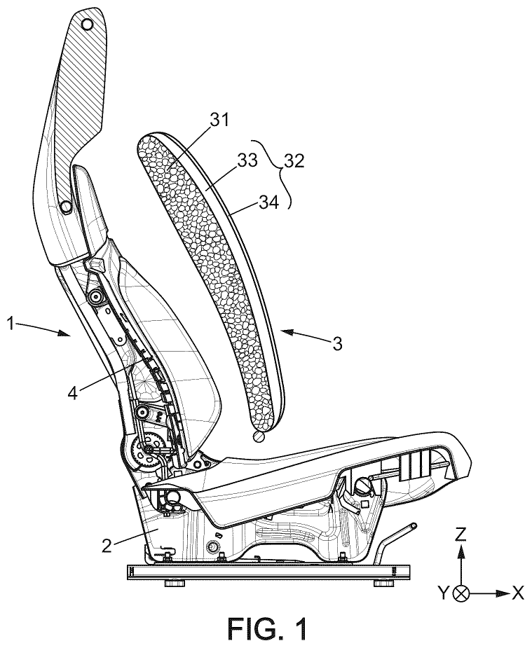

Reference is now made to FIG. 1, which illustrates a seat 1 comprising a structure 2, for example, metal, which may comprise plastic parts, and trim assembly 3 according to one example of the present disclosure, intended for equipping a backrest of seat 1.

The backrest frame may comprise lateral uprights, extending heightwise, as well as an upper crosspiece connecting two upper ends of the uprights. The uprights and the upper crosspiece are, for example, metal sheets which are shaped for example by stamping techniques.

The backrest of seat 1 includes in particular an interface 4, in particular here a backrest interface. It is nevertheless conceivable to provide a similar interface for a seating part onto which trim assembly according to the present disclosure would be applied. This may comprise a material made entirely or partially of plastic. For example, interface 4 is made of ABS (acrylonitrile butadiene styrene) and/or PC (Polycarbonate) and/or (Polypropylene/Polyethylene Copolymer).

In other examples, the interface may comprise a metal suspension mat.

Generally speaking, interface 4, here a backrest interface, may comprise a

shell. The shell may be a molded part or a thermoformed part.

Trim assembly 3 according to the present disclosure comprises:
a first layer of padding 31 comprising a 3D entanglement of irregularly-arranged continuous polyester fibers forming loops welded together.

The polyester fibers of the 3D entanglement of first layer of padding 31 may be hollow fibers and/or solid fibers. The fibers may have a diameter of between 0.2 mm and 2 mm, preferably between 0.3 mm and 1.5 mm. “Continuous” in “continuous fibers” is understood to mean the fact that the length of the fibers is much greater than the diameter of the fibers, and due to the method which is described below, for example, at least by a ratio of 100, or even 500, or even 1000. Very often, and in particular as understandable from the manufacturing method, the fibers, for example, extend from a first end at a first edge of the 3D entanglement and to a second end at a second edge of the 3D entanglement, opposite the first edge.

Preferably, the voids between the fibers of the 3D entanglement of fibers in first layer 31 of padding are left empty. This results in a highly breathable padding, due to the numerous spaces between the fibers which facilitate air circulation.

The trim assembly according to the present disclosure also comprises a cover 32, comprising:
a second layer 33 comprising non-woven polyester fibers,
a decorative third layer 34, comprising polyester fibers woven together,

The second layer comprises an entanglement of non-woven polyester fibers. It may be obtained in particular by a lamination process, and be of a polyester “felt” type. It may optionally comprise a resin binder.

The third layer may comprise polyester fibers woven or knitted together. It may also have a polyester coating on the surface. The third layer has resistance to abrasion, light, and to wear in general, which allows it to retain its appearance throughout the life of the vehicle.

The second layer and the third layer may be bonded together.

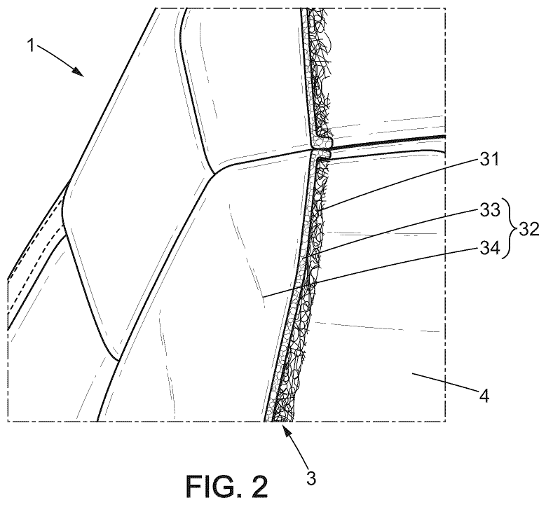

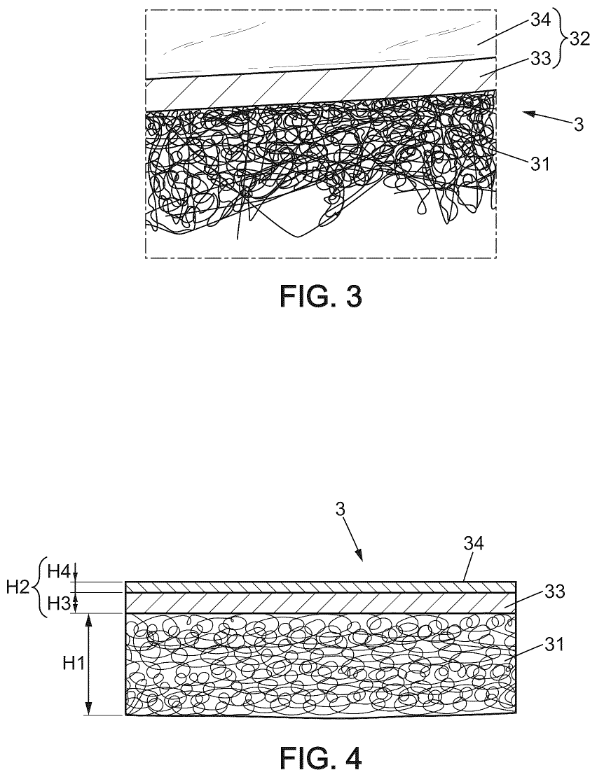

FIGS. 2 and 3 show a 3D model of trim assembly according to one example of the present disclosure.

Interface 4 is particularly visible in FIG. 2, the interface 4 here being in particular a backrest interface 4, and may comprise:
at least one deformable backrest shell receiving trim assembly 3, the deformable shell being configured to take different shapes, notably from an initial position of lumbar lordosis and in particular to a final position of lumbar kyphosis, in response to a variable load applied by the back of the seat occupant,
a system which couples the deformable backrest shell to the structure, comprising upper connections for movement control and lower connections for movement control.

FIG. 4 shows a schematic representation of one example of trim assembly 3 according to the present disclosure.

In this example, thickness H2 of the cover, which represents the addition of thickness H3 of the second layer plus thickness H4 of third layer, may be less than thickness H1 of the first layer of padding.

The cover may be two times, preferably three times less thick than the first layer of padding.

According to some examples, the third layer comprises a thickness H4 of between 1 and 3 mm.

According to some examples, the second layer comprises a thickness H3 of between 2 and 5 mm, or between 2 and 10 mm depending on the need for increased comfort.

According to some examples, the first layer of padding comprises a thickness H1 that is equal to 30 mm.

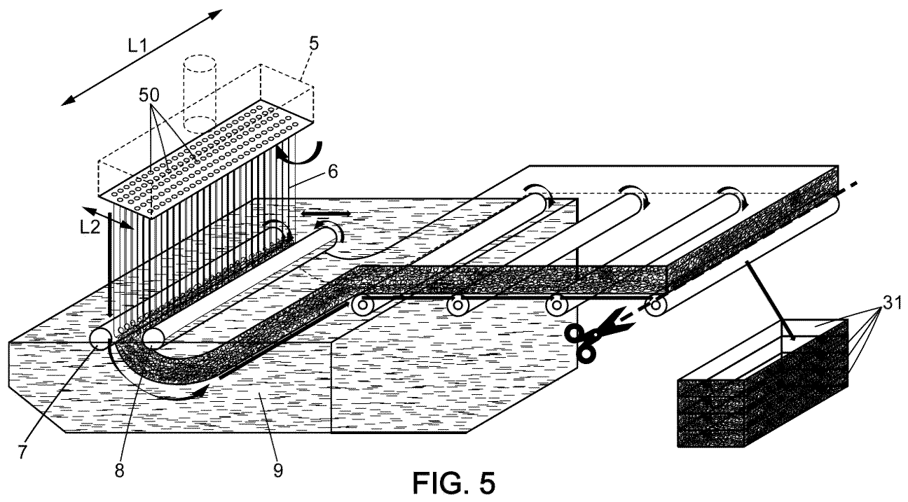

Reference is now made to FIG. 5, which represents an example of a method for manufacturing the first layer of padding according to the present disclosure. The method comprises extruding a thermoplastic polymer, in particular polyester, in an extrusion die 5 of the facility. Extrusion die 5 may in particular be fed granules of thermoplastic polymer, in particular polyester, for example resulting from a recycling process.

Extrusion die 5 comprises extrusion nozzles 50, distributed in a lengthwise direction L1 and in a widthwise direction L2 of extrusion die 5. In /A1/, extrusion die 5 generates a curtain 6 of continuous melted fibers of thermoplastic polymer P, which fall due to gravity. Curtain 6 of continuous melted fibers then passes between two counter-rotating guide members 7, 8, with generation of a 3D entanglement of fibers in an irregular or random distribution, with fusion of loops between the continuous fibers and in a layer in which the total thickness is determined by the center distance between the two guide members 7, 8.

In /A2/, the two guide members 7, 8 are rotated at a speed that is, for example, lower than the speed at which the fibers are falling, providing an accumulation of the fibers which causes the formation of heat-welded loops between fibers, generating the irregular, random, three-dimensional entanglement.

Finally, the 3D entanglement of fibers is solidified by immersion in a cooling liquid 9 to form a padding, which, after a possible cutting operation, allows obtaining the first layer of padding 31. Solidification is obtained just after step /A2/, the two guide members being suitable for being half-immersed in the cooling liquid for this purpose.

The layer of the 3D entanglement of fibers, which is advancing continuously, is then guided out of the tank of cooling liquid in order to be dried, for example, by shaking/vibration. The advancing layer is then cross-cut to obtain different first layers of padding 31, and can be seen in FIG. 5.

According to the inventor's findings, first layer of padding 31 obtained at the end of the method illustrated in FIG. 5 has an apparent density of between 20 kg/m3 and 70 kg/m3, in particular between 45 kg/m3 and 60 kg/m3, preferably between 35 and 70 kg/m3, and in a substantially homogeneous manner. Such a padding density is configured to provide comfort and support for the occupant.

Concerning the cover, second layer 33 may be manufactured according to the following method:
Depositing a blanket of fibers on a mat,
Entangling these fibers with needles perpendicular to the blanket,
Possibly hot calendering,
And possibly additional knitting as well.

Third layer 34 may be manufactured according to the following method:
Warp and weft weaving of polyester threads
Or knitting of polyester threads
Or weaving or knitting, covered with a 90% polyester coating.

Cover 32 may then be added over the first layer of padding to cover it, and fixed to interface 4.

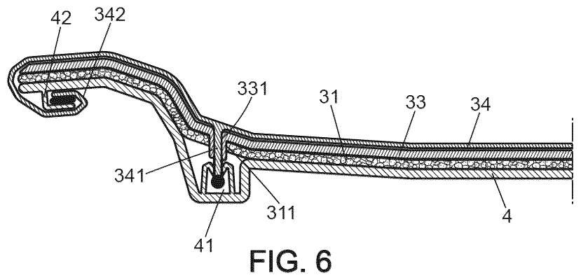

FIG. 6 shows a section view of the trim assembly and of interface 4. In particular, an example assembly of cover 32 on first layer of padding 31 is shown.

Third layer 34 is, for example, bonded to second layer 33. Since the third layer comprises a fastening element 341 projecting towards the trim assembly interior, an opening 331 is provided through the second layer to allow the fastening element to emerge from cover 32, towards the interior of the seat. A passage 311 is provided through first layer of padding 31, passage 311 being configured to allow fastening element 341 to traverse it and emerge from opening 331 of second layer 33 so that it can reach a fastening area 41 provided on interface 4.

Fastening element 341 comprises means for securing itself to fastening area 41, for example clipping means, in order to allow easy disassembly of the cover and/or of the entire trim assembly. Fastening element 341 is preferably made of polyester. The fastening element comprises at least 92% polyester, preferably at least 95% polyester.

Fastening element 341 may be of the tie-down type. According to one example, fastening elements 341 are attachment elements (comprising a non-woven polyester part or strap) which are fixed to the cover at a first end and comprise a rigid element at a second end.

Interface 4 also comprises a peripheral attachment area 42 arranged at the edge of interface 4. The edge is for example a peripheral edge of interface 4. Third layer 34 comprises a rigid portion 342, for example sewn, configured to be housed in peripheral attachment area 42, in the manner of a turned-in edge. For the peripheral edges of the interface, rigid portion 342 may be sewn directly onto cover 32, and folded into peripheral attachment area 42 so as to remain wedged in place when the seat is used.

According to one example, an attachment method for fixing trim assembly 3 to seat 1 comprises:
/B1 Laying first layer of padding 31 on interface 4,
/B2/Passing fastening element 341 through passage 311 in first layer of padding 31 in order to attach it to fastening areas 41 of interface 4.
/B3/Attaching the peripheral edges of cover 32 to interface 4 by cooperation between rigid portion 342 and peripheral attachment area 42.

The method may comprise, prior to /B2/, bonding third layer 34 to second layer 33, with passage of the fastening element through opening 331 of second layer 33.

First layer of padding 31 is then at least partially covered by cover 32. The assembly of cover 32 to interface 4 is detachable. It is possible, according to some examples, to “unclip” fastening element 341 from fastening area 41. It is possible, according to some examples, to urge rigid portion 342 out of peripheral attachment area 42.

Comparative trim assembly may be made at least in part from urethane polymer foam (or polyurethane, PU), in particular from polyurethane foam obtained from polyether/polyol type polyols (or PUR). Such foams can be shaped in molds relatively easily, to form different shapes of padding for different vehicle seat elements, for example such as the seating part, the backrest, the armrest, or the headrest.

Polyurethane foam padding is satisfactory, but may retain moisture, particularly in humid conditions. This can induce a feeling of discomfort for an occupant of the vehicle seat in which an element comprises such padding.

In addition, polyurethane foam may be made by mixing polyols with isocyanates, among other things. The chemical reaction used emits CO2 to form a foam, the emitted CO2 contributing to global warming.

In addition, a polyurethane foam is not recyclable. As a result, at the end of their life, the seats are dismantled for sorting in order to separate out the elements of the various recyclable materials and extract the non-recyclable elements. The recyclable elements are then crushed to form a new raw material, while the non-recyclable elements are, for example, buried, or if possible burned to generate energy.

It thus appears desirable to limit the use of polyurethane in vehicle seat trim assembly, while providing an equivalent level of performance, particularly from the point of view of seat comfort and appearance.

The present disclosure improves the situation.

1. A trim assembly trim assembly comprising:
a first layer of padding trim assembly comprising a 3D entanglement of irregularly-arranged continuous polyester fibers forming loops welded together,
a cover trim assembly comprising:
a second layer trim assembly comprising non-woven polyester fibers,
a third layer trim assembly, decorative and comprising polyester fibers woven or knitted together,
each of the first and second layers trim assembly comprising at least 95% polyester, the third layer trim assembly comprising at least 92% polyester.

2. The trim assembly trim of claim 1, wherein the second layer is bonded to the third layer.

3. The trim assembly trim of claim 2, wherein the second layer is bonded to the third layer with a hot-melt adhesive.

4. The trim assembly trim of claim 3, wherein the hot-melt adhesive comprises at least 95% polyester.

5. The trim assembly trim of claim 1, wherein the cover comprises a fastening element trim assembly configured to fix the cover trim assembly to an interface trim assembly of a vehicle seat trim assembly.

6. The trim assembly trim of claim 5, wherein the fastening element trim assembly comprises at least 95% polyester.

7. The trim assembly trim of claim 6, wherein the first layer of padding trim assembly comprising a passage trim assembly, the fastening element trim assembly being configured to cooperate with a fastening area trim assembly of the interface trim assembly by passing through the passage trim assembly in the first layer of padding trim assembly.

8. The trim assembly trim of claim 1, wherein the second layer trim assembly comprises a thickness trim assembly that is at least two times the thickness trim assembly of the third layer trim assembly.

9. The trim assembly trim of claim 8, wherein the second layer trim assembly comprises a thickness trim assembly of between 2 and 10 mm.

10. The trim assembly trim of claim 9, wherein the thickness trim assembly is between 2 and 5 mm.

11. A vehicle seat trim assembly comprising a backrest portion and a seating part portion which are connected to a structure of the vehicle seat trim assembly, at least one among the backrest and seating part portions comprising a trim assembly trim assembly according to claim 1.

12. The method for manufacturing a trim assembly trim assembly according to claim 1, wherein the manufacturing of the first layer trim assembly comprises:
/A1/Extruding a thermoplastic polymer in an extrusion die comprising extrusion nozzles distributed in a lengthwise direction and in a widthwise direction of the extrusion die, generating a curtain of continuous melted fibers which fall due to gravity,
/A2/Receiving the curtain of continuous melted fibers which fall due to gravity, on one or more support elements, with generation of a 3D entanglement of irregularly-arranged fibers with fusion of loops between the continuous fibers.

13. The method of claim 12, wherein the manufacturing of the first layer trim assembly further comprises:
/A3/Solidifying the 3D entanglement of fibers by immersion in a cooling liquid.

14. An attachment method for fixing a trim assembly trim assembly according to claim 7 to a vehicle seat trim assembly a vehicle seat trim assembly comprising a backrest portion and a seating part portion which are connected to a structure of the vehicle seat trim assembly, at least one among the backrest and seating part portions comprising the trim assembly, the seat trim assembly comprising an interface trim assembly comprising a fastening area trim assembly, the attachment method comprising:
/B1/Laying the first layer of padding trim assembly on the interface trim assembly,
/B2/Passing the fastening element trim assembly through the passage trim assembly in the first layer of padding trim assembly in order to fix it to the fastening areas trim assembly of the interface trim assembly.

15. A method for recycling the vehicle seat trim assembly according to claim 11, comprising:
separating the at least one trim assembly trim assembly from the seat structure trim assembly,
crushing the entirety of the at least one trim assembly trim assembly, with no prior operation of separating layers or layer elements, in order to obtain polyester in the form of granules,
reusing at least part of the polyester granules to manufacture a product comprising polyester.
